(19) United States
(12) Patent Application Publication
(10) Pub. No.: US 2016/0076691 A1
(43) Pub. Date: Mar. 17, 2016

(54) DISPLAY APPARATUS ADAPTED FOR A VARIETY OF PLACEMENTS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WEI-FANG DAI, Shenzhen (CN); CHING-HUA TSAI, New Taipei (TW); JEN-HUI OH, New Taipei (TW); WEN-PIN WANG, New Taipei (TW)

(21) Appl. No.: 14/790,520

(22) Filed: Jul. 2, 2015

(30) Foreign Application Priority Data
Sep. 15, 2014 (CN) 201410467636.7

(51) Int. Cl. F16M 11/06; F16M 11/20; H04N 5/64

(52) U.S. Cl. CPC F16M 11/06; H04N 5/64; F16M 11/2007

(57) ABSTRACT

A display apparatus adaptable to being placed in different locations includes a frame, a display panel received in the frame, at least one rotating portion rotatably connected with the frame, and a base rotatably connected to the at least one rotating portion. The at least one rotating portion is parallel with a back surface of the frame. The base can be perpendicularly located under the frame to support the display apparatus in a first placing orientation, on a table for example, or the center of the base can be swung through 180 degrees to rest substantially flush against the back of the display panel when it is desired that the display apparatus be hung from a wall for example.

### CROSS-REFERENCE TO RELATED APPLICATIONS

This application claims priority to Chinese Patent Application No. 201410467636.7 filed on Sep. 15, 2014, the contents of which are incorporated by reference herein.

### FIELD

The subject matter herein generally relates to a display supports.

### BACKGROUND

A display apparatus includes a frame, a display panel received in the frame, and a base supporting the frame. The base includes a main board, and a power board, which are electrically connected to the display panel. The main board and the power board are disassembled from the base when the display apparatus is to be hung on an external structure.

### BRIEF DESCRIPTION OF THE FIGURES

Implementations of the present technology will now be described, by way of example only, with reference to the attached figures.

FIG. 1 is an isometric view of an embodiment of the display apparatus placed in a first orientation.

FIG. 2 is an isometric view of an embodiment of the display apparatus of FIG. 1 viewed from another angle.

FIG. 3 is an exploded, isometric view of an embodiment of the display apparatus of FIG. 1.

FIG. 4 is an isometric view of an embodiment of the display apparatus placed in a second orientation.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a display apparatus of reduced thickness.

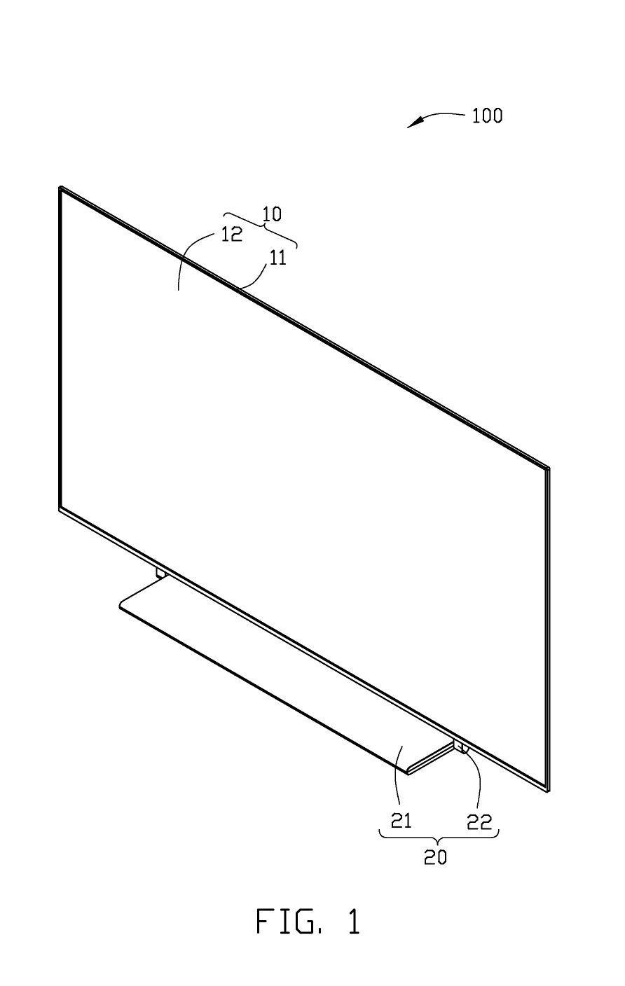

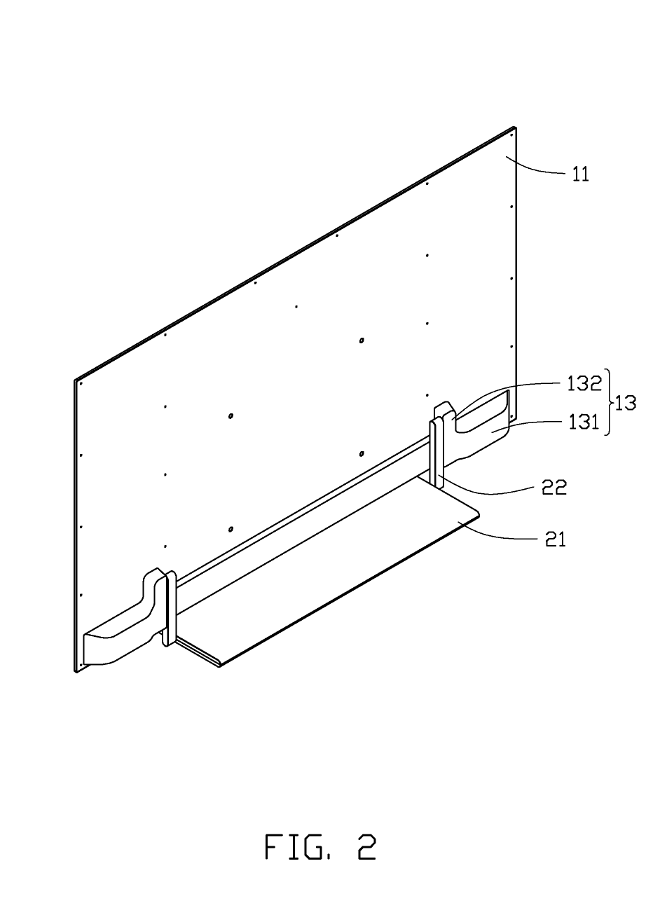

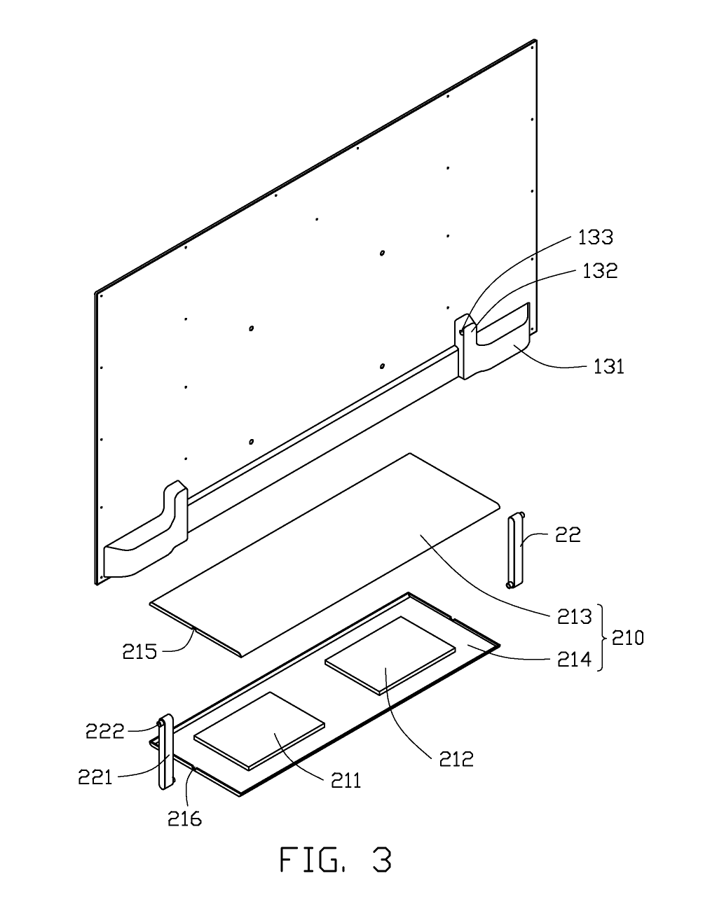

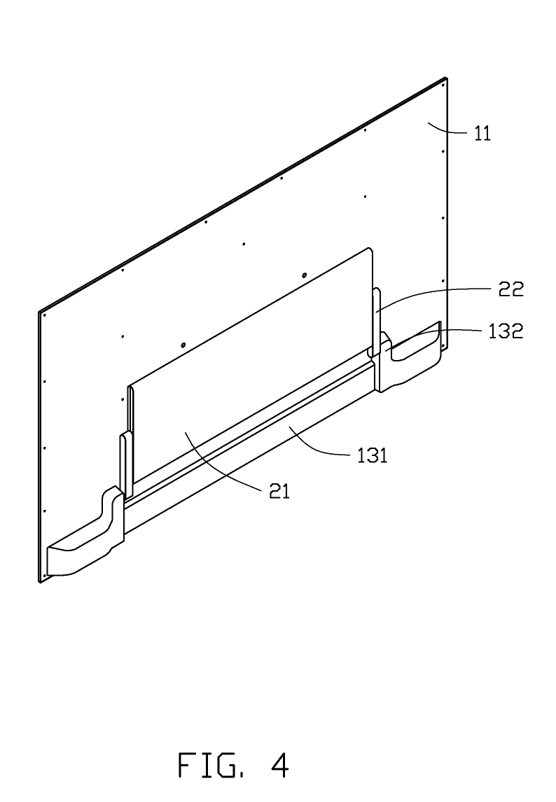

FIGS. 1-4 illustrate an embodiment of the display apparatus 100. The display apparatus 100 can be located in a variety of placements. The display apparatus 100 includes a display mechanism 10 and a location mechanism 20. The location mechanism 20 locates and supports the display apparatus 100 on an external structure, such as when hung on a wall or placed on a table. In at least embodiment, the display apparatus 100 is a television.

The display mechanism 10 includes a frame 11, a display panel 12 received in the frame 11, and a positioning portion 13 mounted on a back surface of the frame 11 away from the display panel 12. The positioning portion 13 includes a fixing portion 131 and two connecting portions 132. The fixing portion 131 is mounted on an edge of the back surface of the frame 11 along a length direction of the frame 11. The ends of the fixing portion 131 are thicker than a middle of the fixing portion 131, the middle of the fixing portion 131 thus forming a first receiving space. The connecting portions 132 are extend from the fixing portion 131 along a width direction of the frame 11. Each of opposite surfaces of the two connecting portions 132 defines a receiving hole 133.

The location mechanism 20 includes a base 21 and two rotating portions 22. The base 21 is rotatably mounted on the display mechanism 10 via the rotating portions 22, and can be received in the receiving space defined in the middle of the fixing portion 131. The base 21 includes a housing 210, a main board 211, and a power board 212. The housing 210 includes an upper cover 213 and a bottom cover 214. The upper cover 213 cooperates with the bottom cover 214 to form a second receiving space for receiving the main board 211, the power board 212, and other electrical components (not shown). The upper cover 213 defines two first gaps 215. The first gaps 215 are located on opposite edges of the upper cover 213. The bottom cover 214 defines two second gaps 216 corresponding to the first gaps 215. The second gaps 216 are located on opposite edges of the bottom cover 214. Each of the first gaps 215 cooperates with a corresponding second gap 216 to form a pivot hole. The main board 211 is a printed circuit board for providing signals and control signals to the display panel 12. The power board 212 is a printed circuit board for providing voltages to the main board 211 and/or the display panel 12. The power board 230 is electrically connected to the main board 211. In at least one embodiment, the first gaps 215 and the second gaps 216 are substantially semicircular. The main board 211 and the power board 212 are arranged in a line along a length direction of the bottom cover 214. The housing 210 is made of metal to form a magnetic shield. In other embodiments, the main board 211 and the power board 212 overlap.

The rotating portion 22 is substantially Z-shaped. An end of the rotating portion 22 is rotatably mounted on the connecting portion 132, and an opposite end of the rotating portion 22 is rotatably mounted on the housing 210. The rotating portion 22 includes a main body 221 and two shafts 222. The main body 221 is substantially rectangular. The shafts 222 are mounted on two opposite ends of the main body 221, and perpendicularly extend from two opposite side surfaces of the main body 221, thus extending in opposite directions. One of the shafts 222 is rotatably inserted into the receiving hole 133, the other shaft 222 is rotatably inserted into the pivot hole formed by the first gap 215 and the second gap 216.

When the display apparatus 100 is placed on a flat surface, for example on a table, the upper cover 213 is locked with the bottom cover 214, and the first gap 215 cooperates with the second gap 216 to receive one of the shafts 222. The other shaft 222 is inserted into the corresponding receiving hole 133. The housing 210 is thus perpendicular to the frame 11 and the main body 221. The rotating portions 22 are located between the connecting portions 132. The main body 221 resists the fixing portion 131. The location mechanism 20 is located directly under the display mechanism 10 for supporting the display mechanism 10. Thus, the display apparatus 100 is placed on the external structure.

When the display apparatus 100 is placed in a second placement, for example on a wall, the base 21 rotates around the shaft 222, until the base 21 resists against the back surface of the frame 11. The base 21 is then parallel with the frame 11. The main body 221 rotates 180 degrees on an axis of the shaft 222, until the main body 221 is located upon the connecting portion 132 and resists against the frame 11. The base 21 then entirely overlaps on the frame 11. Thus, the display apparatus 100 can be hung on the external structure.

In at least one embodiment, the rotating portion 22 is substantially hollow cylinder. A flexible flat cable (FFC) in the base 21 passes through the rotating portion 22, the positioning portion 13, and the frame 11 in that order to be electrically connected to the display panel 12.

In use, based on the rotating portion 22, an orientation of placement of the display apparatus 100 is adjustable. While adjusting the placing orientation of the display apparatus 100, the main board 211 and the power board 212 of the base 21 remains electrically connected to the display panel 12 and no disassembly of the display apparatus 100. Therefore, a convenience of the display apparatus 100 for adjusting placing orientation is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A display apparatus capable of being placed in different locations, the display apparatus comprising:
a frame;
a display panel received in the frame, and the display panel configured to display images;
at least one rotating portion rotatably connected with the frame; and
a base rotatably connected to the at least one rotating portion, and the base configured to support the frame;
wherein the at least one rotating portion is parallel with a back surface of the frame; the base perpendicularly located under the frame to place the display apparatus in a first placing orientation; when the display apparatus is placed in a first placing orientation, the at least rotating portion is perpendicular to the base.

2. The display apparatus of claim 1, wherein the base and the at least one rotating portion simultaneously rotate to be parallel with the back surface of the frame to place the display apparatus in a second placing orientation.

3. The display apparatus of claim 2, wherein the frame comprises a fixing portion; ends of the fixing portion are thicker than a middle of the fixing portion to form a first receiving space in the middle of the fixing portion; when the display apparatus is placed in the first placing orientation, the at least rotating portion is located in the first receiving space formed by the middle of the fixing portion; when the display apparatus is placed in the second placing orientation, the at least rotating portion is located upon the fixing portion.

4. The display apparatus of claim 1, wherein the display apparatus comprises two rotating portions; the frame further comprises two connecting portions corresponding to the rotating portions; the rotating portion comprises a main body and a first shaft; the first shaft is mounted on a side surface of the main body; each of opposite surfaces of the two connecting portion defines a receiving hole; the first shaft is received in the receiving hole.

5. The display apparatus of claim 1, wherein the base comprises a housing, a main board, and a power board; the main board and the power board received in the housing are electrically connected to the display panel.

6. The display apparatus of claim 5, wherein the rotating portion further comprises a second shaft; the housing comprises an upper cover and a bottom cover; the upper cover cooperates with the bottom cover to form a receiving space for receiving the main board and the power board; the upper cover defines two first gaps; the bottom cover defines two second gaps corresponding to the first gap; the first gap cooperates with the corresponding second gap to form a pivot hole for receiving the second shaft.

7. The display apparatus of claim 6, wherein the first shaft and the second shaft are mounted on two opposite ends of the main body, and first shaft and the second shaft are perpendicularly extended from two opposite side surfaces of the main body along two opposite directions.

8. The display apparatus of claim 1, wherein the at least one rotating portion is hollow to establish an electrically connection between the display panel and the main board.

9. A display apparatus capable of being placed in different orientations, the display apparatus comprising:
a frame with a fixing portion;
a display panel received in the frame, and configured to display images; and
a location mechanism outside the frame and configured to rotatably connect to the frame;
wherein the location mechanism rotates along the frame to adjust the display apparatus to be placed in different placing orientations; ends of the fixing portion are thicker than a middle of the fixing portion to forma first receiving space to form a receiving space in the middle of the fixing portion; when the display apparatus is placed in a first placing orientation, the location mechanism is received in the first receiving space formed by the middle of the fixing portion.

10. The display apparatus of claim 9, wherein the location mechanism comprises a base and two rotating portions located on opposite side surfaces of the base; an end of the rotating portion is rotatably connected with the base, and an opposite end of the rotating portion is rotatably connected with the display mechanism; the base is perpendicularly located under the frame to support the frame, and the rotating portion parallel with a back surface of the frame is perpendicular to the base to place the display apparatus in the first placing orientation.

11. The display apparatus of claim 10, wherein the base and the rotating portions simultaneously rotate to be parallel with the back surface of the frame to place the display apparatus in a second placing orientation.

12. The display apparatus of claim 11, wherein when the display apparatus is placed in the first placing orientation, the rotating portions are located in the middle of the fixing portion; when the display apparatus is placed in the second placing orientation, the rotating portions are located upon the fixing portion.

13. The display apparatus of claim 12, wherein the frame further comprises two connecting portions corresponding to the rotating portions; the rotating portion comprises a main body and a first shaft; the first shaft is mounted on a side surface of the main body; each of opposite surfaces of the two connecting portion defines a receiving hole; the first shaft is received in the receiving hole.

14. The display apparatus of claim 13, wherein rotating portion further comprises a second shaft; the housing comprises an upper cover and a bottom cover; the upper cover cooperates with the bottom cover to form a receiving space for receiving the main board and the power board; the upper cover defines two first gaps; the bottom cover defines two second gaps corresponding to the first gap; the first gap cooperates with the corresponding second gap to form a pivot hole for receiving the second shaft.

15. The display apparatus of claim 14, wherein the first shaft and the second shaft are mounted on two opposite ends of the main body, and first shaft and the second shaft are perpendicularly extended from two opposite side surfaces of the main body along two opposite directions.

16. The display apparatus of claim 10, wherein the base comprises a housing, a main board, and a power board; the main board and the power board are received in the housing.

17. The display apparatus of claim 16, wherein the at least one rotating portion is hollow to allow a flexible flat cable (FFC) connected with the main board to pass through for electrically connecting with the display panel.
